(19) United States
(12) Patent Application Publication
(10) Pub. No.: US 2012/0180283 A1
(43) Pub. Date: Jul. 19, 2012

(54) Mobile jack for a storage tank floating roof

(75) Inventors: Kenneth L. Erdmann, Tulsa, OK (US); James W. Ruffin, Broken Arrow, OK (US)

(73) Assignee: Matrix Service, Inc.

(21) Appl. No.: 12/930,848

(22) Filed: Jan. 19, 2011

(51) Int. Cl. B66F 3/24; B66F 3/25; B23P 6/00; B66F 3/28

(52) U.S. Cl. 29/402.08; 254/93 R; 254/93 VA

(57) ABSTRACT

A mobile jack for raising and lowering a floating storage tank roof. The mobile jack includes a fluid-actuated cylinder and ram housed in a jack structure having multiple telescoping sections. The jack is designed to slide onto the forks of equipment to transport the jack to a desired location beneath the roof in preparation for lifting the roof and can be clamped to retain the jack in place during transport. The cylinder and ram are utilized to extend and retract a portion of the jack structure to raise and lower the roof of the floating roof storage tank.

### BACKGROUND OF THE INVENTION

1. Field of the Invention

The present invention relates generally to storage tanks and, more particularly, to storage tanks having floating roofs, that is, roofs that float on material contained in the storage tank and move upwardly and downwardly depending upon the volume of material contained in the tank. More particularly, various embodiments of the present invention provide a system and method for servicing (e.g., maintaining and repairing) floating roof storage tanks. In one example, a mobile jack is provided to raise and lower the roof of a floating roof storage tank in a safe and effective manner to service the tank, for example, to enable replacement of one or more deteriorated sections of the floor of the tank.

2. Description of the Prior Art

By way of background, storage tanks that comprise floating roofs are commonly employed to store fluid materials such as petroleum products. For example, a storage tank having a floating roof is disclosed in U.S. Pat. No. 3,521,416. The disclosure in that patent is hereby incorporated in its entirety by this reference and discloses an example of a floating roof storage tank structure. The storage tank comprises a cylindrical side wall indicated by the numeral 16, a flat floor 17, a center column 18, and a floating roof 36.

The roofs inside such storage tanks float on the products contained in the tanks while the tank is in service. When the tank is empty, multiple legs that extend downwardly move into contact with the floor of the tank to support the roof.

The floors of storage tanks with floating roofs are typically constructed from metal plates that are joined together, for example, by welding. These floor plates are known to deteriorate over time due to corrosion caused by contact with the stored products and electrolysis, as well as mechanical forces including the weight of the stored products, settling due to gravity, and fatigue due to climate changes such as temperature variations. Consequently, the mechanical integrity of the floor plates can be compromised and, also, leaks may result creating a risk of damage to the environment. Therefore, the condition of the floor must be periodically inspected, and the floor plates must be repaired or replaced if damage to the floor is detected.

While repairing or replacing a floor in the storage tank, each of the legs must be lifted to slide a new floor plate(s) under the legs. Furthermore, if a leg is deteriorated, the load on the leg primarily due to the weight of the floating roof must be relieved by lifting the roof so that the deteriorated leg may be removed and replaced. Also, there is typically a leg pad that protects the floor during contact with the leg, which also requires lifting the floating roof to slide the leg pad under the associated leg.

Servicing of floating roof storage tanks is hazardous. Prior to servicing, any remaining stored material is drained from the tank, and consequently the legs support the roof. The roof is typically jacked off the floor to lift the roof and enable the floor plates to be repaired of replaced. However, floating roofs can become unstable and can collapse when jacking the roof to perform the service. The amount of time spent jacking the roof and working under a floating roof while servicing the tank determines the time that a worker is exposed to various risks. Jacking is also an inherently safety-sensitive operation which can jeopardize safety when known jacking equipment is employed to lift the roof.

Thus, there are shortcomings to known jacking equipment for floating storage tank roofs that render the jacking equipment ineffective and/or expose workers to hazards during use. In view of the shortcomings of known jacking equipment, the jacking device in accordance with the embodiments of the present invention will greatly reduce the amount of time required to jack each leg of a floating roof. The jacking device in accordance with the embodiments of the present invention will also provide a very dependable and repeatable jacking method compared to various other techniques commonly used.

The present invention solves the long-extant problem of safely lifting a floating storage tank roof, so that the roof is raised with reduced risk of injury to workers servicing the tank. One preferred embodiment in accordance with the present invention provides a mobile hydraulic floating roof jack and method for lifting the roof of a floating roof storage tank. Furthermore, various embodiments of the present invention provide an improved jacking device of the character described that may be manufactured at low cost.

### SUMMARY OF THE INVENTION

It is a general object of the present invention to provide an apparatus to efficiently and safely lift a roof of a substantially empty floating roof storage tank for the purpose of servicing the tank. Generally, the embodiments in accordance with the present invention provide a mobile jacking device specifically designed for use under floating roofs of storage tanks. For example, one embodiment provides a mobile jacking device adapted to lift a leg attached to the roof, as well as any protective pad between the leg and a floor of the tank, sufficiently above the floor so that the floor, which may comprise a pattern of metal plates that are joined together, can be repaired or a particular plate or plates can be replaced.

Various embodiments are provided in accordance with the present invention. In accordance with one example embodiment, the mobile jacking device comprises a fluid-actuated, for example, a hydraulic, jack for raising the roof of a floating roof storage tank. The jacking device comprises a hydraulic ram cylinder integrated into a structural support system. The support system is designed to slide onto the forks of transport equipment such as a typical skid-steer loader. The forks of the skid-steer loader insert into channels on the base to which the jacking device is mounted and can be clamped to retain the jacking device in place. The mobile jacking device can then be transported to a desired location beneath the roof in preparation for lifting the roof. The hydraulic ram cylinder is preferably constructed to be hydraulically actuated by the hydraulic supply system that is already present on the transport equipment.

In operation, the skid-steer loader operator drives the jacking device from jack point to jack point to position the jack on the floor of the storage tank and then using the onboard hydraulics to actuate the hydraulic ram cylinder to lift the floating roof. The structural support system is designed to have a failure capacity above the hydraulic cylinder capacity, rendering the jacking device inherently safe, as the hydraulic system is incapable of overloading the structure. Also, the jacking device provided by the invention is preferably used by a worker located inside the safety cage of the skid-steer loader, so that additional inherent safety is provided to the worker operating the jacking device.

Accordingly, the jacking device in accordance with the various embodiments of the present invention will greatly reduce the amount of time required to jack each leg of a floating roof. It will also provide a very dependable and repeatable jacking method compared to known commonly used techniques.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 is an isometric view illustrating an embodiment of the jacking device in accordance with the present invention, in which a fluid-actuated ram cylinder or piston is disposed to raise the roof of a floating roof storage tank.

FIG. 2 is an isometric view illustrating the base, the lower section of the housing for the fluid-actuated ram cylinder, and telescoping structure forming the jack, as well as the fluid supply fittings for the actuator of the jacking device, in accordance with the embodiment of the present invention shown in FIG. 1.

FIG. 3 is an isometric view illustrating the upper section of the housing for the fluid-actuated ram cylinder and the middle and upper portions of the telescoping jack structure of the jacking device in accordance with the embodiment of the present invention shown in FIG. 1.

FIG. 4 illustrates a schematic diagram of an example of a mechanism for extending and retracting a telescoping jack structure comprising the embodiment shown in FIG. 1.

FIG. 5 illustrates the embodiment of the mobile jacking device shown in FIG. 1 mounted on the forks of a skid-steer loader to transport the mobile jacking device to a desired location.

### DETAILED DESCRIPTION OF THE PREFERRED EMBODIMENTS

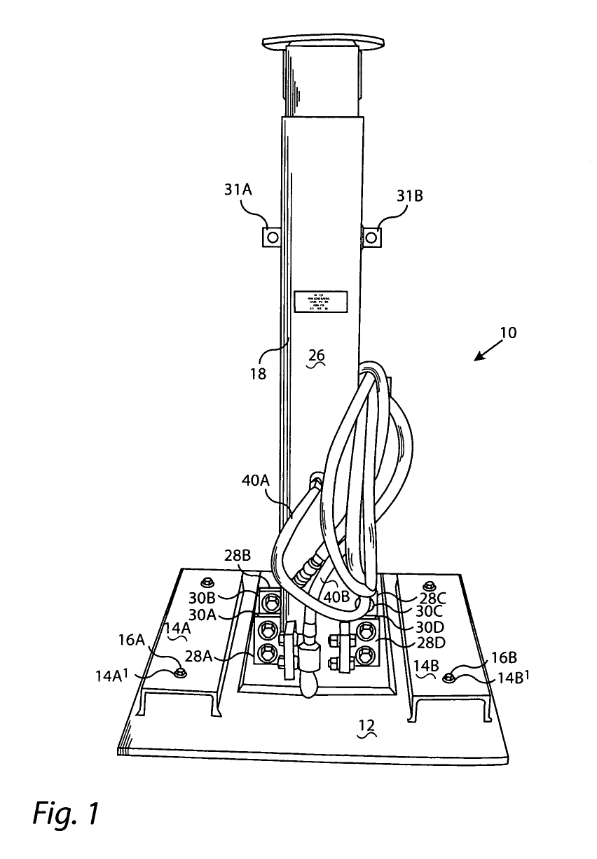

Various example embodiments are contemplated in accordance with the present invention. Referring now to the drawing, FIG. 1 is an isometric view illustrating an embodiment of the jacking device in accordance with the present invention, generally indicated by the numeral 10. The jacking device 10 comprises a roof jack base 12. Preferably, a first channel 14A and a second channel 14B are provided on the base 12. For example, the channels 14A and 14B may be constructed from steel and welded to the base 12. The dimensions of the channels 14A and 14B may be approximately 7.0 inches wide and 2.625 inches high so that they are sized to receive forks of transporting equipment, as will be described in more detail later. The channels 14A and 14B preferably comprise one or more threaded holes 14A1 and 14B1 into which respective bolts 16A and 16B are threaded and which may be tightened to firmly secure the base 12 to the forks of the transporting equipment.

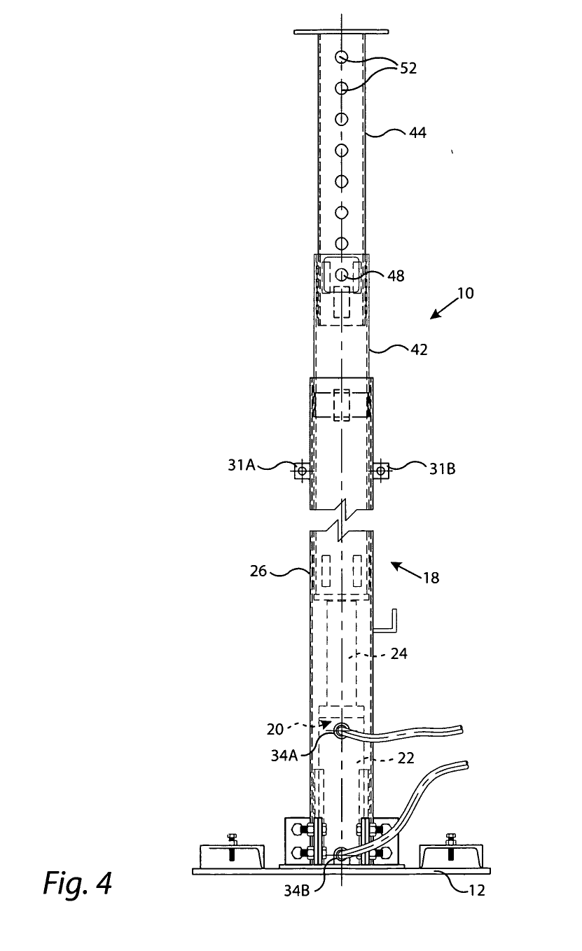

As shown in FIGS. 1 and 4, the jacking device 10 also comprises a jack structure 18 which houses a fluid-actuated actuator 20 to raise the roof of a floating roof storage tank when the fluid-actuated actuator is actuated. As shown in FIGS. 1 and 4, in a first embodiment, the jacking device 10 comprises a hydraulic jack 22 having a ram 24 disposed in a first, or lower, section 26 of the jack structure 18.

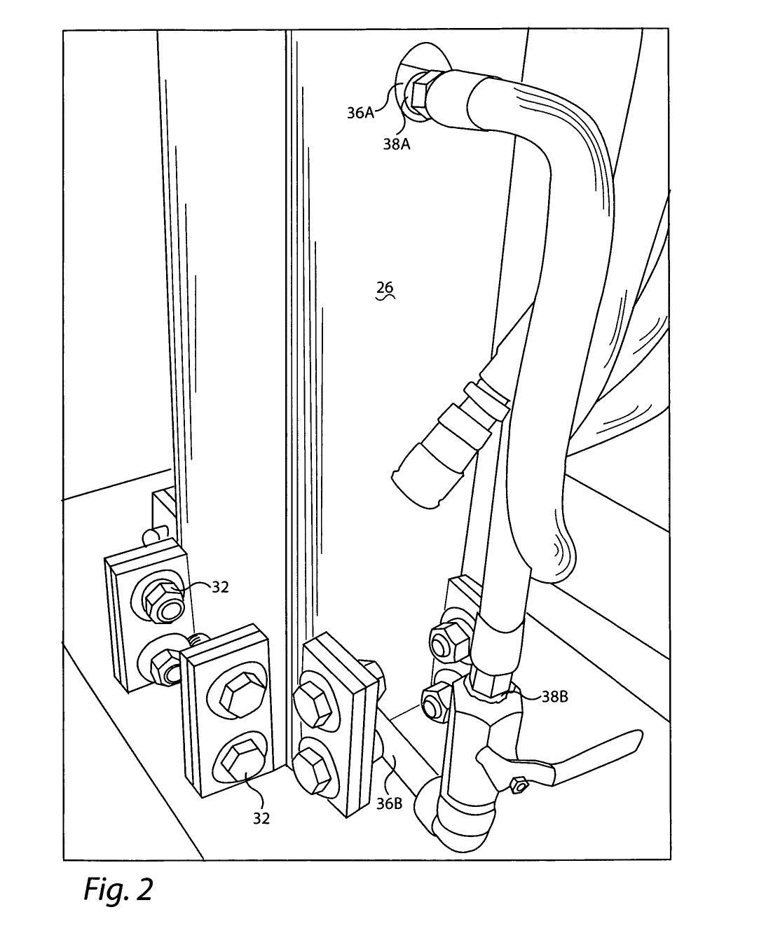

Referring to FIGS. 1, 2, and 4, the lower section 26 of the jack structure 18 comprises a tubular structure, for example, an approximately 8-inch square steel tube. In one example embodiment, the lower section 26 of the jack structure 18 is removably attached to the base 12. In the example embodiment, as best shown in FIGS. 1 and 2, four steel flanges 28A, 28B, 28C, and 28D are attached to the base 12. For example, the flanges 28A-D may be welded to the base 12. Additionally, four steel flanges 30A, 30B, 30C, and 30D are attached to the lower section 26 of the jack structure 18. For example, the flanges 30A-D may be welded to the lower section 26 of the jack structure 18. The flanges 28A-D and 30A-D are provided with holes, for example, two vertically spaced holes. The holes in the respective flanges 28A and 30A, 28B and 30B, 28C and 30C, and 28D and 30D align when the bottom portion of lower section 26 of the jack structure 18 is mated to the base 12. As shown in FIGS. 1 and 4, the lower section 26 of the jack structure 18 may also comprise lifting lugs 31A and 31B to which a hoist (not shown) may be connected to facilitate positioning of the lower section 26 of the jack structure 18 with respect to the base 12 during assembly. After the holes in the flanges 28A-D and 30A-D are aligned, securing means 32, for example, bolts that extend through the aligned holes and onto which a washer and lock washer are placed and then a nut is threaded, is employed to securely attach the lower section 26 of the jack structure 18 to the base 12. The base 12 of the jacking device 10 preferably includes these bolted connections so that the jacking device can be disassembled to remove and replace the hydraulic cylinder 22 and ram 24 if necessary.

In the example embodiment shown in FIG. 4, the hydraulic jack 22 having the ram 24 is disposed in the lower section 26 of the jack structure 18. In order to actuate the hydraulic jack 22 to extend or retract the ram 24, access holes 34A and 34B are provided in the lower section 26 of the jack structure 18. As shown in FIG. 2, cylinder nipples 36A and 36B extend through respective holes 34A and 34B. Cylinder couplings 38A and 38B are attached to cylinder nipples 36A and 36B, respectively. Preferably, cylinder couplings 38A and 38B are hydraulic quick coupler type couplings. Hydraulic supply lines, or hoses, 40A and 40B may then be attached employing the cylinder couplings 38A and 38B, respectively, as shown in FIGS. 1, 2, and 4.

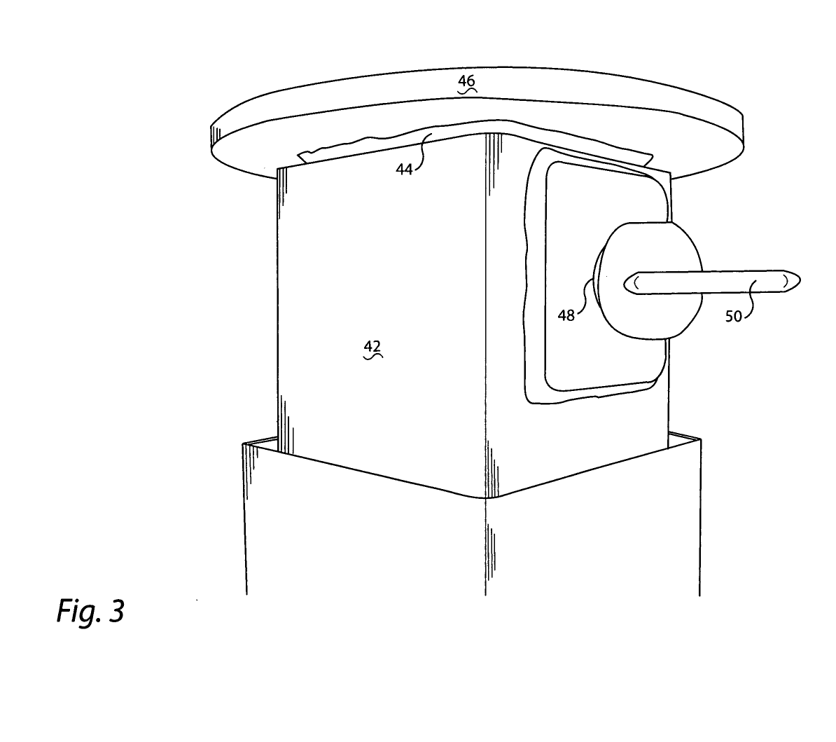

As shown in FIGS. 1, 3, and 4, the example embodiment of the jack structure 18 also preferably comprises a second, or middle, section 42 comprising a tubular structure, for example, an approximately 7-inch square steel tube. As shown in FIG. 4, the middle section 42 of the jack structure 18 is slidably mounted within the lower section 26 of the jack structure, and the bottom of the middle section is engaged by the top of the ram 24. Accordingly, when the hydraulic cylinder 22 is actuated to extend or retract the ram 24, the middle section 42 of the jack structure 18 telescopes upwardly or downwardly within the lower section 26 of the jack structure.

In accordance with the example embodiment shown in FIGS. 1, 3, and 4, the jack structure 18 also preferably comprises a third, or upper, section 44 comprising a tubular structure, for example, an approximately 6-inch square steel tube, to which a roof-engaging circular plate, or pedestal, 46 is attached. For example, the pedestal 46 may be a 1.0-foot circular steel plate welded to the top of the upper section 44 of the jack structure 18. As shown in FIG. 4, the upper section 44 of the jack structure 18 is slidably mounted within the middle section 42 of the jack structure, such that the upper section of the jack can telescope within the middle section. However, a reinforced hole 48 is preferably provided in the top portion of the middle section 42 of the jack structure 18 to accommodate a hitch pin 50. Also, a plurality of holes 52 is provided along the length of the upper section 44 of the jacking structure 18. For example, the holes 52 may be spaced approximately 4.0 inches apart center-to-center. Consequently, the upper section 44 of the jacking structure 18 can be locked in position with respect to the middle section 42 by aligning one of the holes 52 in the upper section with the hole 48 in the middle section and inserting the hitch pin 50 through the aligned holes. Therefore, when the hydraulic cylinder 22 is actuated to extend or retract, the middle section 42 and upper section of the jack structure 18 telescope together with respect to the lower section 26 of the jack structure. As a result, the top of the jacking device 10 preferably has an extension section that can be pinned in position at various lengths. This allows the jacking device 10 to be employed for various heights of floating roofs, but still utilize a commercially available hydraulic cylinder 22 typically having a standard 18-inch stroke.

The jack structure 18 and hydraulic cylinder 22 in accordance with an example embodiment are preferably constructed to have a tight fit and have a stable base 12 so that the jacking device 10 does not allow excessive lateral movement of the floating roof when the roof is lifted. To this end, spacers (not shown) may be welded to the interior corners or interior or exterior surfaces of the square tubes utilized to construct the lower section 26, middle section 42, and/or upper section 44 if needed to provide a tight fit of the hydraulic cylinder 22 within the lower section 26 and/or to reduce the gap between the various sections of the jack structure 18 to enable the sections to telescope without allowing unacceptable wobble of the sections.

The jack structure 18 is preferably designed to have a failure capacity above the rated capacity of the hydraulic cylinder 22. Consequently, the jacking device 10 is inherently safe as the hydraulic supply system is incapable of overloading the structure.

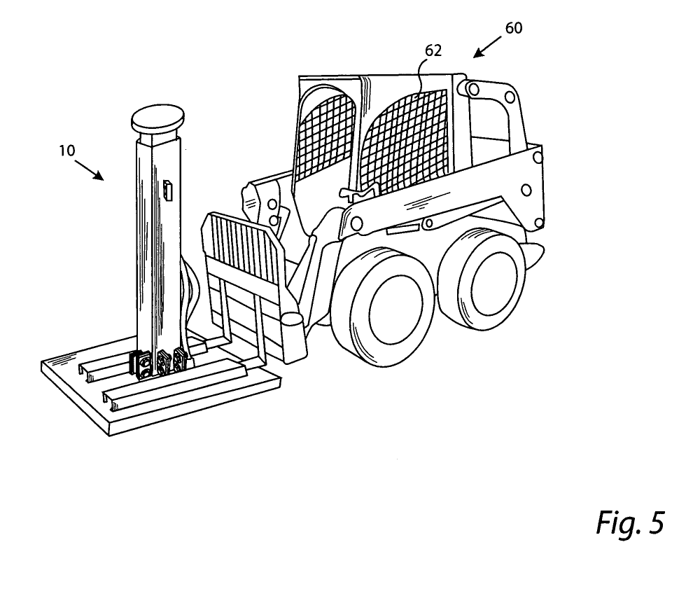

In operation, referring to FIGS. 4 and 5, an operator of transporting equipment, for example, a skid-steer loader 60 having a protective cage 62, drives the jacking device 10 from jack point to jack point. At each jack point, the operator locates the jacking device 10 on the floor of the storage tank and positions the pedestal 46 directly beneath the desired contact area of the floating roof. Then, using the onboard hydraulics of the skid-steer loader 60, the operator hydraulically actuates the hydraulic cylinder 22 to extend the ram 24 and impart upward movement to the middle and upper sections 42 and 44 of the jack structure 18 to raise the floating roof.

In summary, the jacking device 10 in accordance with the various example embodiments shown in FIGS. 1-5 and described above comprises a hydraulic cylinder 22 and ram 24 integrated into a structural support system comprising the base 12 and first section 26 of the jack structure 18. The support system is designed to slide onto and be transported using the forks of a typical transporting equipment, such as a skid-steer loader, fork lift, or the like. The forks of the transporting equipment insert into channels 14A and 14B on the base 12 to which the jacking device 10 is mounted and can be clamped to retain the jacking device in place. After the jacking device 10 is selectively positioned at a desired location beneath the floating roof, the hydraulic cylinder 22 is adapted to be hydraulically actuated by the hydraulic supply system that is already present on the transporting equipment to extend and retract the second section 42 of the jack structure to lift the floating roof. During operation, the operator of the transporting equipment is preferably protected within a protective cage.

While the foregoing description has been with reference to particular examples of embodiments of the present invention, it will be appreciated by those skilled in the art that changes in these embodiments may be made without departing from the principles and spirit of the invention. For example, other structures known to those persons skilled in the art may alternatively be employed for extending and retracting a ram such as the ram 24 shown in FIG. 4, for example, a pneumatic cylinder. Alternatively, a mechanically actuated ram may be substituted, for example, a rotated screw-driven device. Furthermore, the materials of construction may be varied to suit the requirements for any specific load capacity. Accordingly, the scope of the present invention can only be ascertained with reference to the appended claims.

What is claimed is:

1. A mobile jack to raise and lower the roof of a floating roof storage tank, comprising:
a base;
a first channel and a second channel provided on the base having dimensions sized to receive forks of external transporting equipment;
a jack structure;
an actuator housed in the jack structure and adapted to extend and retract a portion of the jack structure to contact the roof and raise or lower the roof.

2. The jack of claim 1, further comprising one or more threaded holes in the first and second channels into which respective bolts are threaded and which are selectively tightened to secure the base to the forks of the transporting equipment.

3. The jack of claim 1 wherein the base is mounted to the forks of the external transporting equipment when the roof is raised or lowered to provide additional stability for the jack structure so that the risk that the base may kick out is reduced.

4. The jack of claim 1 wherein the jack structure comprises a first section and a second section slidably mounted within the first section, a bottom portion of the second section being engaged by the actuator, the second section telescoping upwardly or downwardly within the first section when the actuator is actuated to extend or retract, respectively.

5. The jack of claim 1 wherein the actuator is a fluid-actuated actuator.

6. The jack of claim 4 wherein the actuator is a fluid-actuated actuator.

7. The jack of claim 6 wherein the fluid-actuated actuator comprises a hydraulic jack having a ram, the actuator being housed in the first section of the jack structure.

8. The jack of claim 4 wherein the first section of the jack structure comprises a first tubular structure and the second section comprises a second tubular structure and inside dimensions of the first tubular structure are larger than outside dimensions of the second tubular structure.

9. The jack of claim 1 wherein the first section of the jack structure is removably attached to the base.

10. The jack of claim 9, further comprising first flanges attached to the base; second flanges attached to the first section of the jack structure; the flanges each being provided with one or more holes adapted to align when a bottom portion of the first section is mated to the base; and securing means that extend through the aligned holes employed to securely attach the first section to the base.

11. The jack of claim 1, further comprising a plurality of lifting lugs attached to the jack structure adapted to be connected to an external hoist to facilitate positioning the first section with respect to the base during assembly.

12. The jack of claim 7, further comprising a plurality of access holes provided in the first section of the jack structure, a cylinder nipple extending through each hole, a cylinder coupling attached to each cylinder nipple, and a hydraulic supply line or hose attached to each cylinder coupling.

13. The jack of claim 12 wherein each cylinder coupling is a hydraulic quick coupler type coupling.

14. The jack of claim 4 wherein the jack structure further comprises a third section having first and second ends, the first end of the third section being slidably mounted within the second section of the jack structure, such that the third section of the jack structure can telescope within the second section.

15. The jack of claim 8 wherein the jack structure further comprises a third section, the third section comprising a third tubular structure, and inside dimensions of the second tubular structure are larger than outside dimensions of the third tubular structure.

16. The jack of claim 14 wherein the second section of the jack structure comprises a hole and the third section of the jack structure comprises a plurality of holes provided along a length of the third section, and further comprising a hitch pin, so that the third section can be locked in position with respect to the second section when one of the holes in the third section is aligned with the hole in the second section and the hitch pin is inserted through the aligned holes, whereby the second section and third section telescope together with respect to the first section of the jack structure when the actuator is actuated to extend or retract.

17. The jack of claim 16 wherein the actuator is a fluid-actuated actuator disposed in the first section and having an 18-inch maximum stroke and wherein the third section is adjusted to be locked in position with respect to the second section when one of the holes in the third section is aligned with the hole in the second section and the hitch pin is inserted through the aligned holes, whereby a standard actuator can be used for any roof height to raise or lower the roof and the actuator remains disposed within the first section and thus provides safe operation because the actuator cannot raise the second section to an unsafe height.

18. The jack of claim 14, further comprising a roof-engaging pedestal attached to the second end of the third section of the jack structure.

19. The jack of claim 1 wherein the jack structure has a failure capacity above a rated capacity of the actuator so that the actuator is incapable of overloading the structure.

20. A method for jacking the roof of a floating roof storage tank, comprising the steps of:
transporting a jacking device selectively attachable to transporting equipment having a protective cage occupied by an operator of the transporting equipment to a jack point using the transporting equipment;
locating the jacking device on a floor of the storage tank beneath a desired contact area of the floating roof; and
using power supplied by the transport equipment to actuate the jacking device to lift or lower the floating roof;
thereby enabling a single worker to transport and position or remove the jacking device and lift or lower the floating roof while safely protected in the cage.

21. The method of claim 20 wherein the power supplied by the transporting equipment is hydraulic power.

22. The method of claim 20 wherein the transporting equipment is a skid-steer loader.

23. The method of claim 20, further comprising the step of repairing or replacing one or more plates comprising the floor of the storage tank after the floating roof is raised and maintained the raised position, thereby reducing the risk to workers.

24. The method of claim 20, further comprising the step of repairing or replacing one or more legs attached to the floating roof while the operator of the transporting equipment remains safely protected in the cage.
